(19) United States
(12) Patent Application Publication
(10) Pub. No.: US 2005/0026500 A1
(43) Pub. Date: Feb. 3, 2005

(54) Electrical connector assembly with improved latch means

(76) Inventors: Renhua Ji, Kunsan (CN); Yi Sheng Lin, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/902,761

(22) Filed: Jul. 30, 2004

(30) Foreign Application Priority Data
Jul. 31, 2003 (CN) 03277306.4

(51) Int. Cl. H01R 13/648

(52) U.S. Cl. 439/607

(57) ABSTRACT

An electrical connector assembly includes a first electrical connector (10) having first contacts (13) provided therein and a second electrical connector (2) having second contacts provided therein. The first connector includes a metal cover (10) defining a locking hole (11) therein. The second connector has a metal shell (4) shielding the second connector. The shell includes a resilient spring arm (421) integrally attached thereto. The arm has a cam (422) raised inwardly therefrom and retainably received in the locking hole of the first connector.

### BACKGROUND OF THE INVENTION

1. Field of the Invention

The present invention relates to a electrical connector which are mounted on a printed circuit board. In particular, the invention relates to a connector assembly which has a shielding means for EMI protection.

2. Description of the Prior Art

Conventional high speed connectors comprise a plug and a receptacle interconnected through contact fingers. Such connectors form a grounding means surrounding the adjoining surfaces of the receptacle and the plug in order to afford electromagnetic interference (EMI) shielding around the contact fingers. In conventional connectors, the grounding mechanism has a latching mechanism.

An example of such a plug connector is disclosed in U.S. Pat. No. 5,660,558 issued to Osanai et al. on Aug. 26, 1997. The Osanai connector includes an insulator defining a pair of grooves, a shell held to the insulator, and a hood attached to the shell. The shell includes a shielding portion cover the insulator for EMI protection, and a pair of coupling portions formed integrally with the shielding portion. Each coupling portion includes a hook portion received in a corresponding groove of the insulator and engaging nails protruding beyond the groove. The hood includes an elastic portion on an upper portion o the shell. During insertion into a mating connector, exert a downward force on the elastic portion of the hood, the coupling portion of the shell is pressed downwardly, the engaging nails is pushed into the grooves and further received in locking holes of the mating connector, then the coupling portion is released and the engaging nails is further locked in the locking holes of the mating connector, and thus a secure connection is obtained.

However, mating faces between the engaging nails and the locking holes are relative small and easy to be damaged after repeated insertion and withdraw with the mating connector. Moreover, this conventional connector needs enough space to press the elastic portion of the hood during engage and disengage with the mating connectors. Therefore, this latch means is inconvenient when used in relative small space, such as internal spaces of electronic appliances.

Hence, an improved latch means of the mated electrical connectors is desired to overcome the foregoing shortcomings.

### BRIEF SUMMARY OF THE INVENTION

A main object of the present invention is to provide an electrical connector with a reliably latch means which is easy to be manufactured.

Another object of the present invention is to provide an electrical connector assembly having an improved shell for Electro-Static-Discharge (ESD) which can assure an electrical interconnection therebetween.

An electrical connector assembly includes a first electrical connector having first contacts provided therein and a second electrical connector having second contacts provided therein. The first connector includes a metal cover defining a locking hole therein. The second connector has a metal shell shielding the second connector. The shell includes a resilient spring arm integrally attached thereto. The arm has a cam raised inwardly therefrom and retainably received in the locking hole of the first connector.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector assembly according to the present invention;

FIG. 2 is another perspective view of FIG. 1;

FIG. 3 is a perspective view of a plug connector of the electrical connector assembly;

FIG. 4 is a perspective view of a receptacle connector of the electrical connector assembly;

FIG. 5 is an exploded view of FIG. 4;

FIG. 6 is another exploded view of FIG. 4 from a different aspect;

FIG. 7 is a partially assembled view of FIG. 6, wherein a plurality of receptacle contacts and a cable assembly are assembled within a dielectric housing.

### DETAILED DESCRIPTION OF THE INVENTION

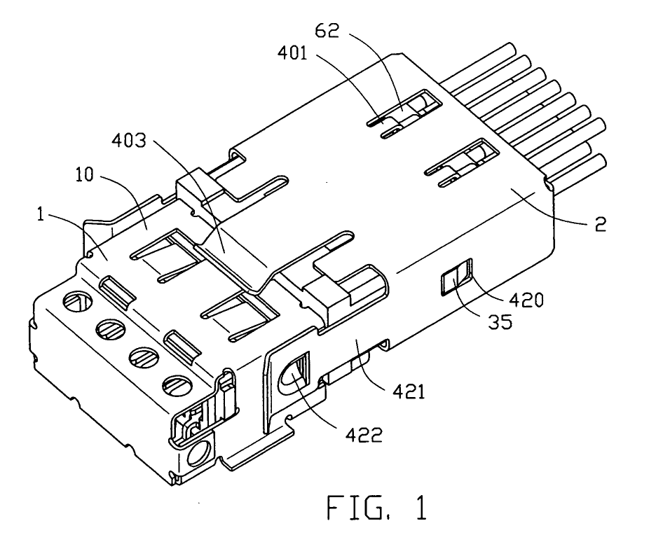

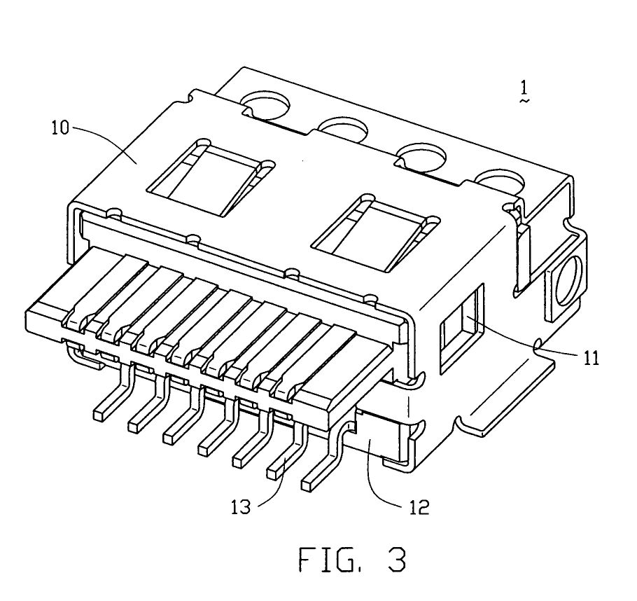

Referring to FIGS. 1, 2 and 3, an electrical connector assembly (not labeled) of the present invention mounted on a main printed circuit board (PCB, not shown) includes a plug connector 1 and a receptacle connector 2 mating with the plug 1. The plug 1 includes a plug body 12, a plurality of plug contacts 13 received in the plug body 12 and a metal cover 10 surrounding and shielding the plug body 12. The cover 10 defines a pair of locking holes 11 in both sides therein.

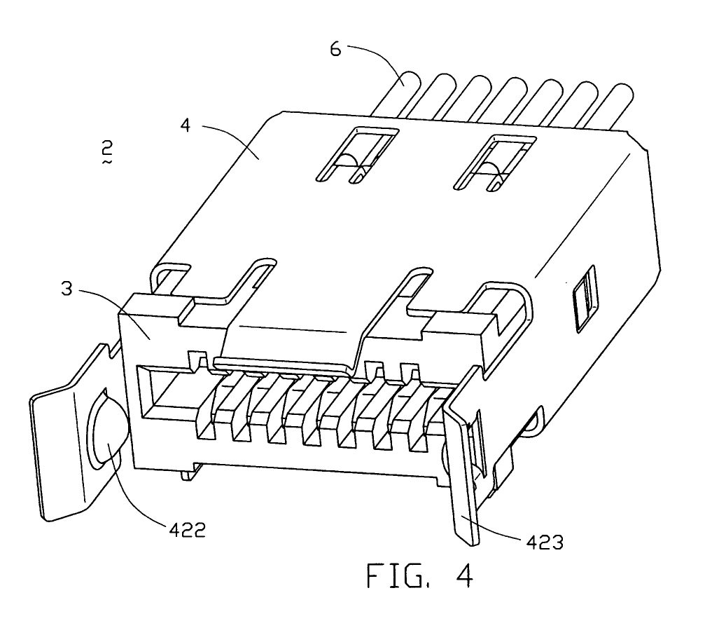

Referring to FIGS. 4, 5 and 6, the receptacle connector 2 includes a dielectric housing 3, a shell 4, a plurality of receptacle contacts 5 received in the housing 3 and a cable assembly 6 connecting with the receptacle contacts 5.

The housing 3 includes a mating portion 30 for mating with the plug 1 and two rows of receiving cavities 31 defined adjacent to the mating portion 30. A pair of openings 32 are defined in an upper and lower surfaces of the housing 2 away from the mating portion 30. A plurality of passages 33 are spaced apart and communicating with respective ones of the receiving cavities 31. Each opening 32 has a keeper portion 34 extending inwardly from opposite sides therefrom. The housing 2 further has a pair of retention portions 35 projecting outwardly from both sides of the housing 2.

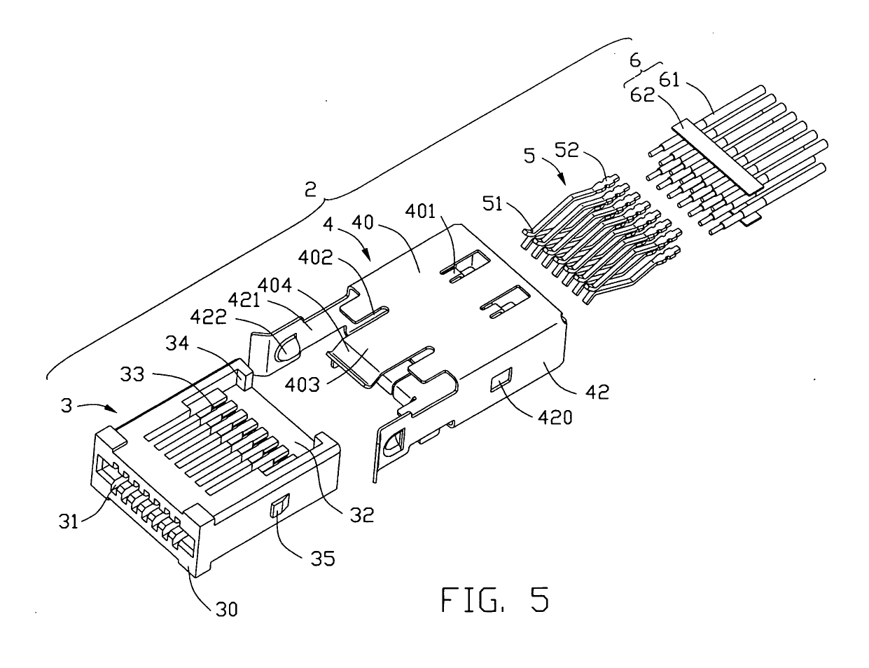

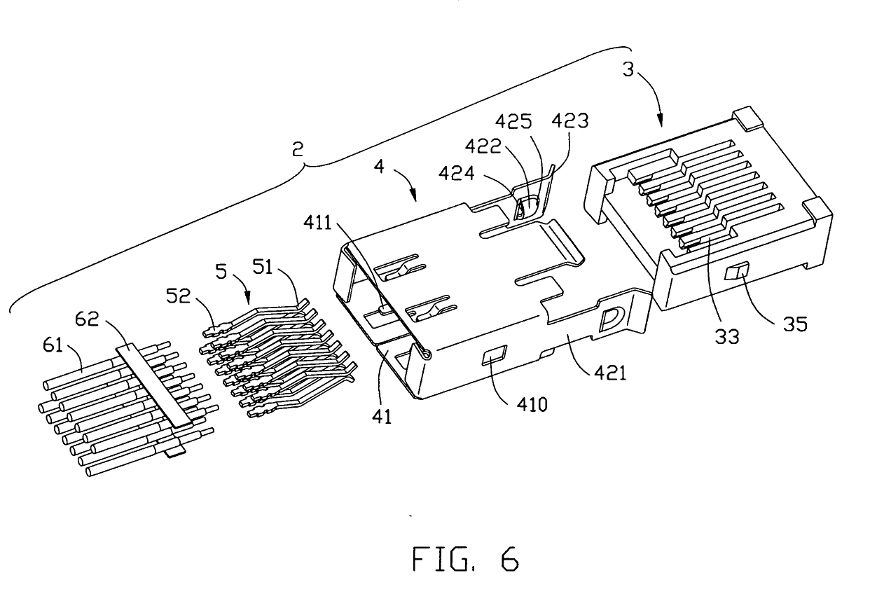

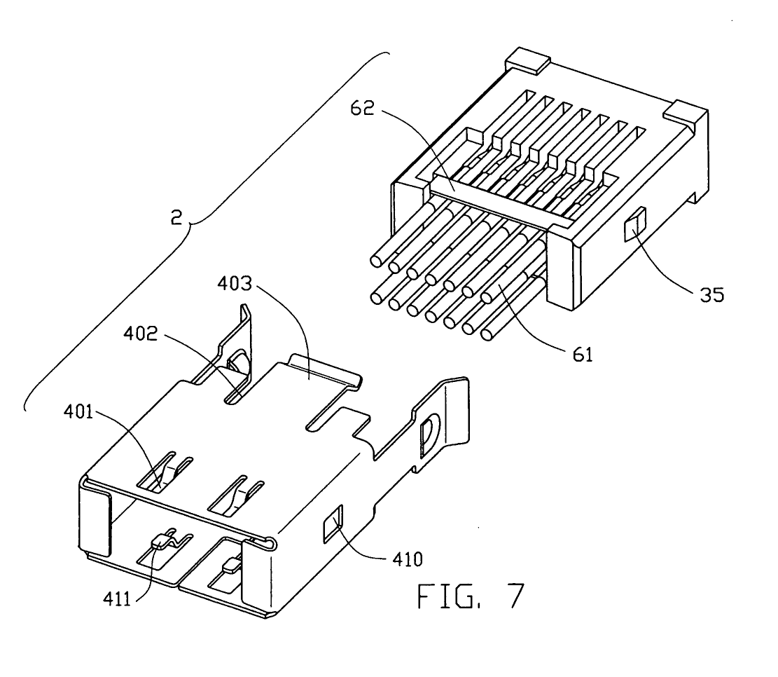

As best shown in FIG. 6 in conjunction with FIG. 5 and 7, the shell 4 is stamped from one metal sheet and includes an upper plate 40, bottom plate 41 and two side plates 42. Each of the upper plate 40 and the bottom plate 41 has a plurality of grounding tabs 401, 411 extending inwardly therefrom. The upper plate 40 defines a pair of notches 402 in a front portion thereof, thereby forming a cantilever beam 43 between the notches 402. The beam 43 has an arc shaped head portion 404 extending downwardly from a free end of the beam 43. The head portion 404 acts as a lead-in surface and a clamp when the plug 1 is mated together. Each side plate 42 defines a retention hole 420 for engaging with the retention portion 35. Each side plate 42 further includes a resilient spring arm 421 extending forwardly therefrom. Each arm 421 has a cam 422 raised inwardly and oppositely facing each other. Each cam 422 includes an engaging surface 424 and a convex guiding surface 425 immediately in front of the engaging surface 424. The engaging surfaces 424 are substantially perpendicular to inner side surfaces of corresponding arms 421 and are oriented opposite to free ends of the arms 421. The convex guiding surfaces 425 face toward free ends of the corresponding arms 421 and act as lead-in surfaces during the receptacle 2 mating with the plug 1. Each arm 421 further includes a lead-in surfaces 423 extending outwardly from a free end thereof.

Each receptacle contact 5 includes a contacting portion 51 for mating with the plug 1 and a tail portion 52 for connecting with the cable assembly 6.

The cable assembly 6 is of two rows and each includes a plurality of cables 61 and a ground bar 62 connecting with the cables 61. The cables 61 are substantially micro coaxial cables and each includes a jacket insulator layer, a braid layer, an inner insulator layer and a center conductor (not shown). The structure and the function of the micro coaxial cable is well known to those skilled in the art, a detailed description is omitted herein. The ground bar 62 is soldered with the braid layers (not shown) of the cables 61.

Referring to FIGS. 4 through 7, in assembly, the contacting portions 51 of the receptacle contacts 5 are inserted into the housing 3 along respective ones of the passages 33 and spaced along the receiving cavities 31. The cables 61 of the cable assembly 6 extend along the corresponding passages 33 thereafter, while the ground bars 62 are blocked by the keeper portions 34 respectively. The center conductors (not shown) of the cables 61 are soldered with respective ones of the tail portions 52 of the receptacle contacts 5. Finally, the shell 4 substantially surrounds the housing 3. The shell 4 covers the housing with the upper and the bottom plates 40, 41 along an upper and an bottom surfaces (not labeled) respectively, and the grounding tabs 401, 411 of the upper and bottom plates 40, 41 pressing the ground bars 62, as such the retention portion 35 of the housing 3 are interference fitted in the retention holes 420 of the side plates 42. The beam 403 and the arms 421 extend beyond the mating portion 30 of the housing 3 for mating with the plug 1.

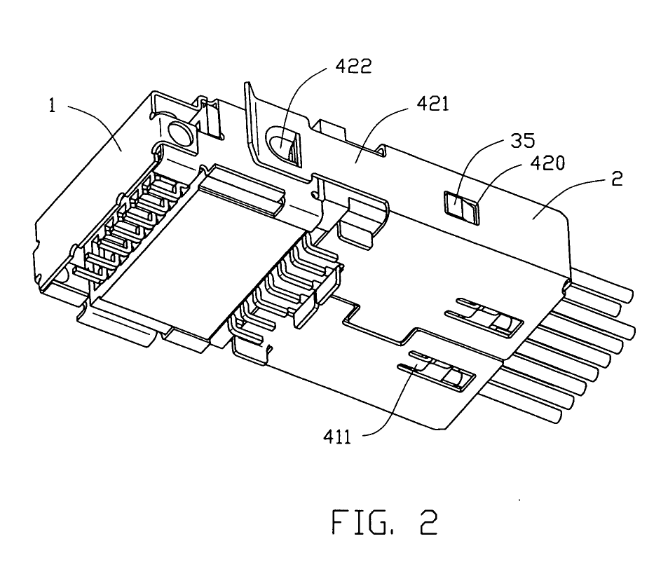

FIGS. 1 and 2 show the plug 1 and the receptacle 2 in fully mated condition. During mating, a free end of the plug 1 is effective to engage the lead-in surfaces 423 of the arms 421 respectively, to gradually deflect the arms 421 outwardly and gradually increase the insertion forces until the plug contacts 13 engage with the receptacle contacts 5, as such the plug 1 slides along the convex guiding surfaces 425 of the cams 422 of the receptacle 2, thus the cams 433 are radially inwardly received in the locking holes 11 of the plug 1, and the head portion 404 of the beam 403 abuts against a top surface of the cover 10. It can be seen that when the mating complete, the engaging surfaces 424 of the cams 422 of the receptacle 2 latchably abuts against inner side surface of the locking holes 11 of the plug 1. It is difficult for the engaging surface 424 to unmate form the inner side surface of the locking holes 11 and to slide out of the locking holes 11. Therefore, the plug 1 and the receptacle 2 are reliably connected together.

It should be noted that as the mating occurs, the arms 421 of the shell 4 of the receptacle 2 connect with the metal cover 10 of the plug 1 before the plug contacts 13 contact with the receptacle contacts 5. Therefore, the static electronics deposited on the connectors are discharged prior to data transmitting and power current flowing between the plug 1 and the receptacle 2.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

1. An electrical connector assembly, comprising:
a first connector having first contacts provided therein, the first connector defining
a locking hole in an outer periphery thereof; and
a second connector engaging with the first connector, the second connector including second contacts provided therein and a metal shell shielding the second connector, the shell including a resilient spring arm integrally attached thereto, the arm having a cam raised inwardly therefrom;
wherein when assembled, the cam of the second connector is latchably engaged with the locking hole of the first connector.

2. The electrical connector assembly according to claim 1, wherein the first connector includes a metal cover, the locking hole being defined in a side of the cover.

3. The electrical connector assembly according to claim 2, wherein the metal cover of the first connector engages with the metal shell of the second connector before the first contacts electrically connect with the second contacts of the second connector.

4. The electrical connector assembly according to claim 1, wherein the second connector includes a mating portion, the resilient spring arm extends beyond the mating portion for engaging with the first connector.

5. The electrical connector assembly according to claim 1, wherein the cam includes a rear engaging surface and a front convex guiding surface immediately in front of the engaging surface.

6. The electrical connector assembly according to claim 5, wherein the rear engaging surface abuts against inner side surface of the locking hole of the first connector.

7. The electrical connector assembly according to claim 1, wherein the second connector has a cable assembly connecting with the contacts, the cable assembly including a plurality of cables electrically connecting with the second contacts respectively and a ground bar soldered with the corresponding cables.

8. The electrical connector assembly according to claim 7, wherein the shell of the second connector includes an upper plate and a bottom plate each having a plurality of grounding tabs extending inwardly therefrom, the grounding tabs abutting against the grounding bar.

9. The electrical connector assembly according to claim 1, wherein the shell defines a cantilevered beam in a front portion thereof, the beam has an arc shaped head portion extending downwardly from a free end thereof, the head portion extending beyond the mating portion and biasing against the first connector.

10. An electrical connector comprising:
a dielectric housing having a mating portion;
a conductive contact secured in the housing and extend forwardly for electrically connecting with terminal of a mating connector; and
a metal shell enclosing the housing, the shell including a resilient spring arm integrally formed therewith, the arm having an engaging surface generally projecting upright therefrom and facing away a free end thereof for latchably engaged with the mating connector, and a tapered convex guiding surface closely in front of the engaging surface and facing toward the free end thereof.

11. The electrical connector according to claim 10, wherein the wherein the shell defines includes a cantilevered beam, the beam has an arc shaped head portion extending downwardly from a free end thereof, the head portion extending beyond the mating portion and biasing against the first connector.

12. An electrical connector assembly, comprising:
a first connector having a plurality of first contacts provided therein and a first metallic shield defining a locking hole therein; and
a second connector engaging with the first connector, the second connector including a plurality of second contacts provided therein and a second metallic shielding defining a resilient spring arm extending beyond a mating face of the second connector with a locking cam thereon;
wherein when assembled, the locking cam of the second shield is electrically and latchably engaged with the locking hole of the first shield.

13. The electrical connector assembly as claimed in claim 12, wherein said second metallic shield further includes another spring arm extend beyond the mating face of the second connector while without any locking cam thereon.

14. The electrical connector assembly as claimed in claim 12, wherein said second connector is mechanically connected to wires.
